(19) United States
(12) Patent Application Publication
(10) Pub. No.: US 2019/0392968 A1
(43) Pub. Date: Dec. 26, 2019

(54) Thick-Film Aluminum Electrode Paste with Pretreatment before Metal Plating for Fabricating Chip Resistor

(71) Applicant: Wenshou Co., Ltd., Kaohsiung (TW)

(72) Inventor: Wen-Hsi Lee, Kaohsiung (TW)

(21) Appl. No.: 16/438,636

(22) Filed: Jun. 12, 2019

(30) Foreign Application Priority Data
Jun. 25, 2018 (TW) 107121738

(51) Int. Cl. H01C 17/28; H01C 1/142; H01C 17/00; H01B 1/16; C03C 8/18; C03C 8/04; C03C 8/08; C03C 8/10; C03C 4/14

(52) U.S. Cl. CPC H01C 17/283; H01C 1/142; H01C 17/006; H01B 1/16; C03C 8/18; C03C 2209/00; C03C 8/08; C03C 8/10; C03C 4/14; C03C 2204/00; C03C 8/04

(57) ABSTRACT

A thick-film aluminum (Al) electrode paste is provided to fabricate a chip resistor. The paste is a mixture of a vanadium-zinc-boron series glass (V₂O₅—ZnO—B₂O₃ or BaO—ZnO—B₂O₃) along with a metal oxide, aluminum granules, and an organic additive, whose proportions are separately 3˜30 wt %, 0.1˜15 wt %, 50˜70 wt %, and 10˜20 wt %. After being stirred through three rollers and filtered, the paste is pasted on an alumina ceramic substrate. The pasted substrate is dried and sintered for forming a thick-film aluminum electrode. Meanwhile, before processing metal plating that follows, an anti-plating pretreatment is performed. Therein, surface irregularities and nonconductive alumina on the surface are removed. Thus, the electrode obtains smooth flat surface and low oxygen content. The characteristics of the chip resistor using the thick-film aluminum electrode are equivalent to those using thick-film printed silver electrodes and those using thick-film printed copper electrodes sintered in a reducing atmosphere.

### TECHNICAL FIELD OF THE INVENTION

The present invention relates to an aluminum (Al) electrode for a chip resistor; more particularly, to a thick-film Al electrode paste for forming the Al electrode to fabricate the chip resistor, where the Al electrode is capable of being electroplated (with a pretreatment), highly conductive (with a high metal content), highly thermally dissipative (with a vanadium(V)-oxide series glass) and highly dense with few pores (with the V-oxide series glass); and the thick-film Al electrode paste for forming the Al electrode has specific composition to fabricate the chip resistor with an anti-plating pretreatment.

### DESCRIPTION OF THE RELATED ARTS

A thick film printed electronic device needs conductive electrodes for connection to work well. On consideration of high conductivity, modernly-used conductive electrodes are mainly fabricated through sintering a metal silver (Ag) in the air or a metal copper in a reducing atmosphere. However, when there is sulfur existed in the environment, the conductive electrode will be sulfurized so that the conductivity is significantly reduced and the function of the conductive electrode is lost. To solve the sulfurization problem of the conductive electrode, a conductive thick-film printed Al electrode having high conductivity was proposed. The proposed conductive Al electrode did not react with sulfur in a general sulfurization reliability test. Sulfurization was avoided and the original high conductivity of the electrode were still maintained.

However, the main disadvantages of the thick-film-printed Al electrode include the followings: (a) Its conductivity is much lower than that of the thick-film printed Ag electrode sintered in the air and that of the the thick-film printed copper electrode sintered in the reducing atmosphere. (b) After sintering, its porosity is too high yet its density is too small. (c) Metal is hard to be further plated owing to an oxide layer easily generated on the surface of the Al electrode. These problems for the conductive Al electrode would cause the following troubles on applying the fabrication of the chip resistor: (1) The resistance is unstable after laser trimming (as conductivity is too low). (2) The resistance will drift after the subsequent thermal treatment (as density is small with too many pores formed after sintering). (3) Its weldability is so poor that nickel and tin are not plated easily (on the surface of oxide layer or glass). (4) The resistances greatly vary for short-term overload voltage tests (as heat-dissipation is bad with too many pores formed after sintering).

As is described above, the modern chip resistor and its terminal electrodes are mainly made of conductive Ag material. However, metallic Ag easily reacts with sulfur in environment and generates silver sulfide thereby to further affect the features of the chip resistor. In particular environments having high temperatures, high humidity, and high sulfur concentrations, reactions in applications like automotive electronics are especially vigorous. At present, for producing an anti-sulfurization chip resistor for automobile, a high content of palladium (Pd) (more than 5 mole percent) is added to an Ag terminal electrode to form an Ag—Pd alloy for reducing the reaction activity of forming silver sulfide with sulfur. As a result, the material cost of the terminal electrode has a dramatic rise and, as the curing environment becomes more severe, there is a certain risk of forming silver sulfide. Hence, the prior arts do not fulfill all users' requests on actual use.

### SUMMARY OF THE INVENTION

The main purpose of the present invention is to replace the original Ag terminal electrode with an Al terminal electrode for significantly reducing material cost.

Another purpose of the present invention is to replace the original Ag terminal electrode with the Al terminal electrode for completely overcoming the original sulfurization problem for chip resistors and solving the conventional problem of material migration of the Ag electrode under high voltage and high humidity, which greatly benefits the applications of the chip resistors in the field of automobile electronics.

To achieve the above purposes, the present invention is a composition of thick-film Al electrode paste, where the composition is of a conductive Al paste to form a terminal electrode of a chip resistor on an Al ceramic substrate; the composition comprises an RO-zinc(Zn)-boron(B)-based glass, a metal oxide (MO), Al granules, and an organic additive; in the total weight of the RO—Zn—B-based glass, the Al granules, and the organic additive, the RO—Zn—B-based glass has a content of 3˜30 weight percent (wt %), the MO has a content of 0.1˜15 wt %, the Al granules has a content of 50˜70 wt %, and the organic additive has a content of 10˜20 wt %; and the RO—Zn—B-based glass is a V—Zn—B-based glass (V₂O₅—ZnO—B₂O₃) or a barium(Ba)—Zn—B-based glass (BaO—ZnO—B₂O₃). Accordingly, a novel composition of thick-film Al electrode paste is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the flow view showing the fabrication of the preferred embodiment according to the present invention;

FIG. 2 is the view showing the anti-plating treatment;

FIG. 3 is the view showing the comparison of surface denseness between the conductive aluminum (AI) paste using the RO-zinc(Zn)-borate(B)-based glass and that using the bismuth(Bi)—Zn—B-based glass;

FIG. 4 is the view showing the comparison of internal microstructure between the conductive Al paste using the RO—Zn—B-based glass and that using the Bi—Zn—B-based glass;

FIG. 5 is the view showing the comparison of thermostability between the conductive Al paste using the RO—Zn—B-based glass and that using the Bi—Zn—B-based glass;

FIG. 6 is the view showing the comparison of the short-term overload test between the conductive Al paste using the RO—Zn—B-based glass and that using the Bi—Zn—B-based glass;

FIG. 7 is the sectional view showing the chip resistor fabricated with the conductive Al paste using the two high-and-low-temperature layers of the RO—Zn—B-based glass;

FIG. 8 is the sectional view showing the chip resistor using the preferred embodiment; and

FIG. 9 is the view showing the comparison of material migration of the Ag electrode and the Al electrode of the chip resistor under high voltage and high humidity.

### DESCRIPTION OF THE PREFERRED EMBODIMENT

The following description of the preferred embodiment is provided to understand the features and the structures of the present invention.

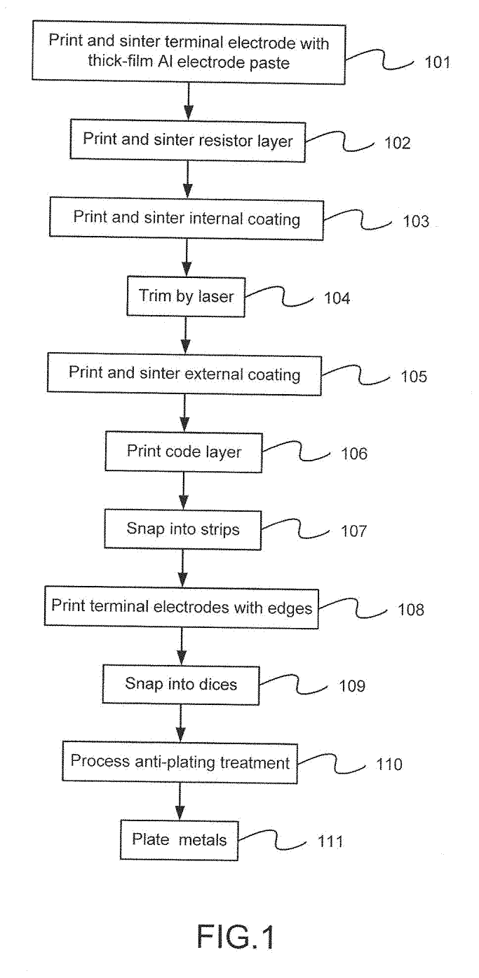

Please refer to FIG. 1 to FIG. 9, which are a flow view showing the fabrication of a preferred embodiment according to the present invention; a view showing an anti-plating treatment; a view showing comparison of surface denseness between a conductive Al paste using a RO—Zn—B-based glass and that using a Bi—Zn—B-based glass; a view showing comparison of internal microstructure between the conductive Al paste using the RO—Zn—B-based glass and that using the Bi—Zn—B-based glass; a view showing comparison of thermostability between the conductive Al paste using the RO—Zn—B-based glass and that using the Bi—Zn—B-based glass; a view showing comparison of a short-term overload test between the conductive Al paste using the RO—Zn—B-based glass and that using the Bi—Zn—B-based glass; a sectional view showing a chip resistor fabricated with a conductive Al paste using two high-and-low-temperature layers of the RO—Zn—B-based glass; a sectional view showing a chip resistor using the preferred embodiment; and a view showing comparison of material migration of an Ag electrode and an Al electrode of the chip resistor under high voltage and high humidity. As shown in the figures, the present invention is a composition of a thick-film Al electrode paste for forming a terminal electrode of a chip resistor, where the terminal electrode can be electroplated (through a pretreatment), highly conductive (with a high metal content), highly thermally dissipative (with a vanadium(V)- or barium(Ba)-oxide-based glass) and highly dense with few pores (with the V- or Ba-oxide-based glass). The thick-film Al electrode paste comprises an RO—Zn—B-based glass (V₂O₅—ZnO—B₂O₃ or BaO—ZnO—B₂O₃, O=oxygen), a metal oxide (MO), Al granules, and an organic additive, where, in the total weight of the RO—Zn—B-based glass, the MO, the Al granules, and the organic additive, the RO—Zn—B-based glass has a content of 3˜30 weight percent (wt %), the MO has a content of 0.1˜15 wt %, the Al granules has a content of 50˜70 wt %, and the organic additive has a content of 10˜20 wt %; the 3˜30 wt % RO—Zn—B-based glass is added to a mixture of the 50˜70 wt % Al granules, the 0.1˜15 wt % MO, and the 0.10˜20 wt % organic additive to be stirred through three rollers and filtered to obtain the conductive Al paste; and the MO comprises silicon oxide (SiO₂), manganese oxide (MnO₂), copper oxide (CuO), chromium oxide (Cr₂O₃), zirconium oxide (ZrO₂), aluminum oxide (Al₂O₃), boron oxide (B₂O₃), zinc oxide (ZnO), and lithium oxide (Li₂O). In the total weight of the SiO₂, MnO₂, CuO, Cr₂O₃, ZrO₂, Al₂O₃, B₂O₃, ZnO, and Li₂O, SiO₂ has a content of 1˜15 wt %; MnO₂ has a content of 1˜15 wt %; CuO has a content of 1˜15 wt %; Cr₂O₃ has a content of 115 wt %; ZrO₂ has a content of 115 wt %; Al₂O₃ has a content of 1˜5 wt %; B₂O₃ has a content of 25˜30 wt %; ZnO has a content of 25˜30 wt %; and Li₂O has a content of 15 wt %.

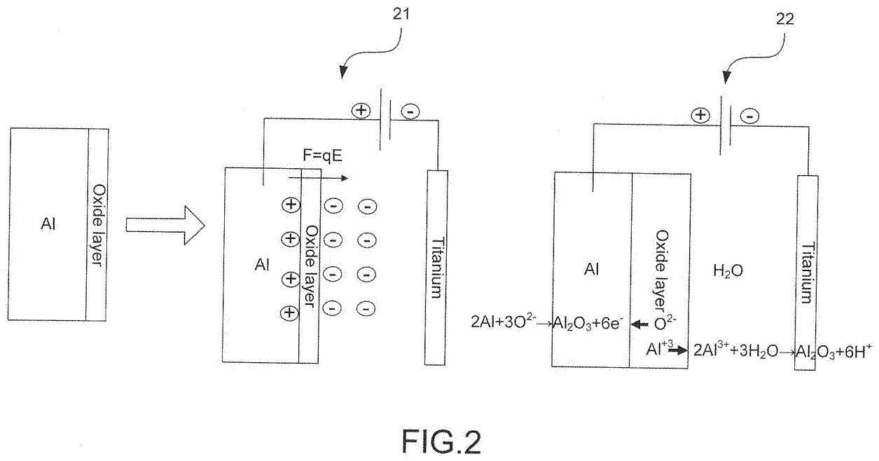

On using the present invention, by using a thick-film screen printing technology, a thick-film Al electrode paste (e.g. V—Zn—B-based glass) is directly formed into an Al terminal electrode on an alumina ceramic substrate to replace the terminal electrode formed of the original conductive silver (Ag) paste for fabricating a chip resistor. As shown in FIG. 1, a standard thick-film screen printing is used for fabricating the chip resistor with the coordination of the alumina ceramic substrate, comprising sequential steps of: (a) printing and forming terminal electrodes by sintering the thick-film Al electrode paste 101; (b) printing and sintering a resistor layer 102; (c) printing and sintering an internal coating 103; (d) trimming by laser 104; (e) printing and sintering an external coating 105; (f) printing a code layer 106; (g) snapping into strips 107; (h) printing terminal electrodes with edges 108; (i) snapping into dices 109; (j) processing an anti-plating treatment 110; and (k) plating metals (nickel and tin) 111. Thus, the chip resistor is fabricated with the thick-film Al electrode paste. Therein, the anti-plating treatment which includes a moderate anti-plating treatment (pre-reaction of anodic pretreatment) 21 and an excessive anti-plating treatment (moderate anodic treatment) 22 is shown in FIG. 2.

The conductivity, dissipation rate and density (porosity) of the thick-film-printed Al electrode mainly relate to the composition of the glass of thick-film Al paste coordinated with the formula of the Al metal powder. The present invention reveals the relationship between the characteristics of the thick-film-printed Al electrode applied to a chip resistor and the composition of the glass of thick-film conductive Al paste along with a pretreatment of the thick-film Al electrode before metal plating.

According to Table 1, the conductive Al paste of the RO—Zn—B-based glass is sintered at 600° C. and 850° C., where the MO is SiO₂, MnO₂, CuO, Cr₂O₃, ZrO₂, Al₂O₃, B₂O₃, ZnO, and Li₂O; and the conductive Al paste is compared with other conductive Al pastes of Zn—B-based glass:

Firstly, an absolute relationship is found between the conductivity of the thick-film-printed Al electrode and the metallic Al contents, the Al particle sizes, and the added glass amount contained in the metallic Al paste. Therein, the conductivity of the Al electrode increases as the Al solid content increases; the conductivity is better with bigger Al granules; a very low glass content with too much pores results in low connectivity; and, yet, the connectivity of Al is significantly reduced with a high insulation rate owing to the too high glass content.

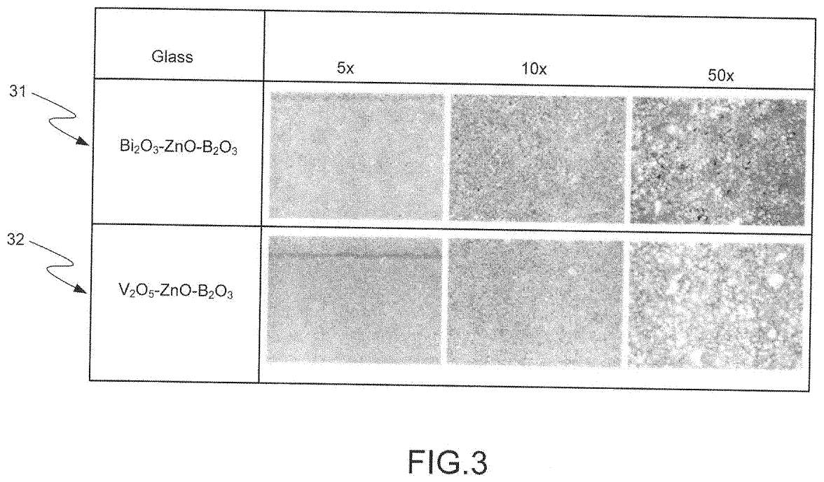

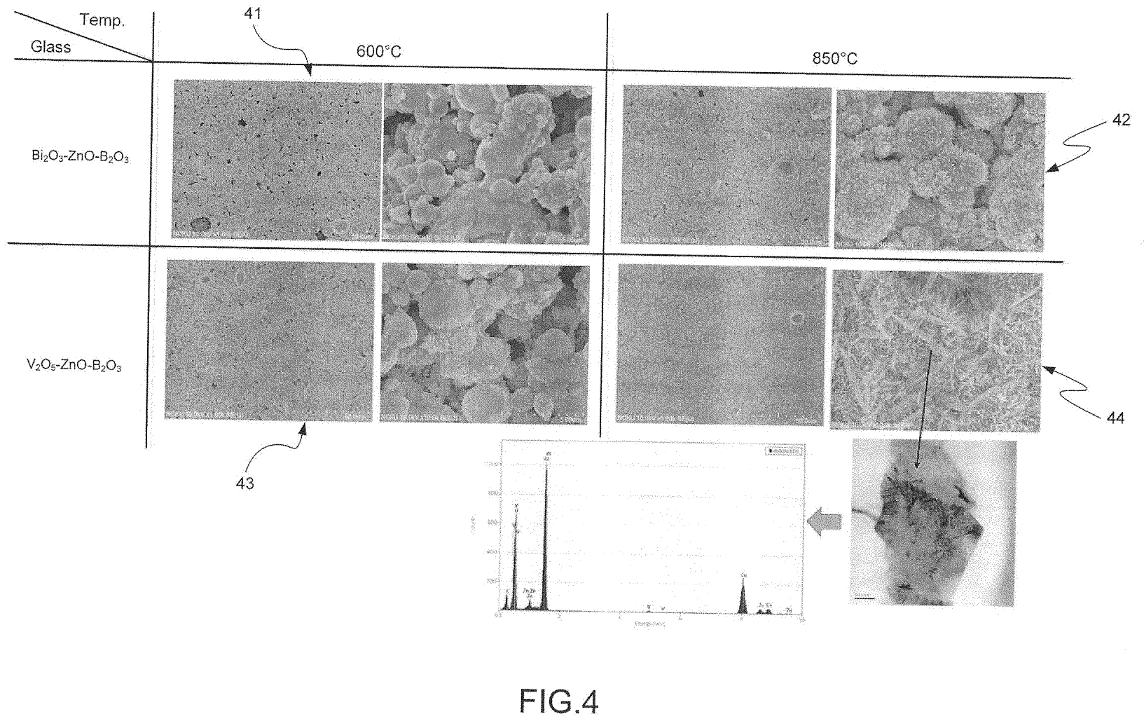

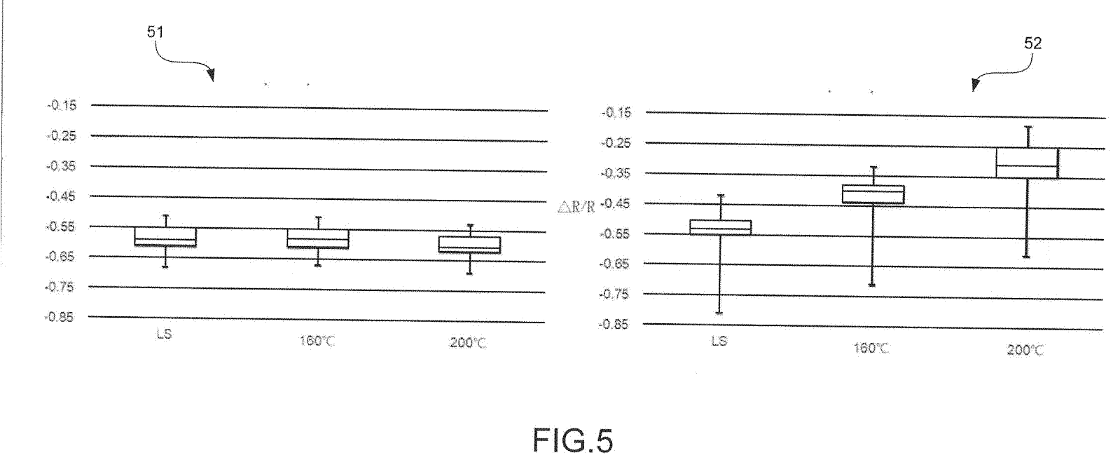

Next, regarding the thermostability of the thick-film-printed Al electrode (thermally treated at 200° C.), only the RO—Zn—B-based glass is most helpful for improving the thermostability for the chip resistor. In FIG. 3, a surface density comparison between a conductive Al paste of a Bi—Zn—B-based glass (Bi₂O₃—ZnO—B₂O₃) 31 sintered under 850° C. and a conductive Al paste of the RO—Zn—B-based glass 32 according to the present invention is shown. In FIG. 4, an internal microstructure comparison between the conductive Al pastes of the RO—Zn—B-based glass sintered under 600° C. and 850° C. 41,42 according to the present and the conductive Al pastes of the Bi—Zn—B-based glass sintered under 600° C. and 850° C. 43,44 is shown. In the comparisons shown in FIG. 3 and FIG. 4, it is apparent that the structure becomes loose because a chain structure increases with the content increase of V₂O₅ or BaO in the glass. Hence, the temperature of the softening point is lowered for easily obtaining the thick-film Al paste with high density and low porosity. In FIG. 5, a thermostability comparison between a chip resistor fabricated with the conductive Al paste of the Bi—Zn—B-based glass 51 and a chip resistor fabricated with the conductive Al paste of the RO—Zn—B-based glass 52 both sintered under 850° C. is shown. Therein, it is found that the present invention is of great help to the thermostability of the terminal electrode of the chip resistor.

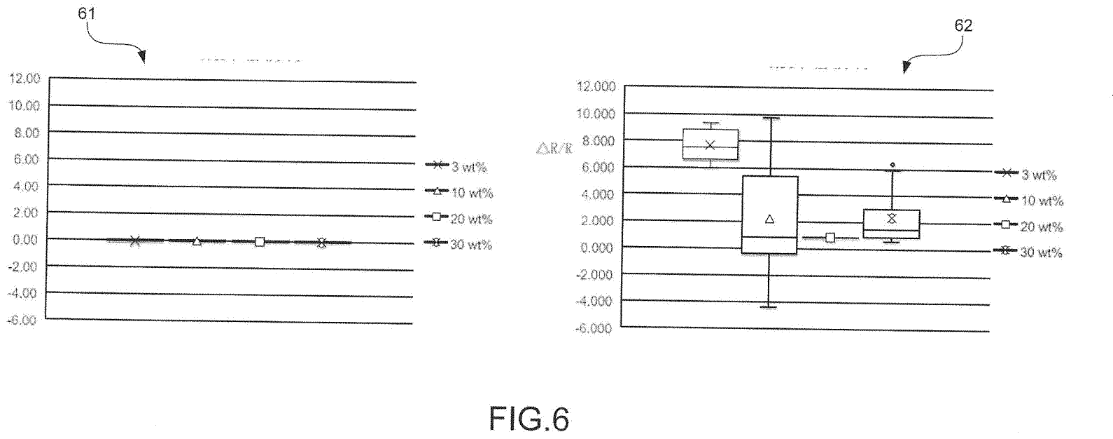

Furthermore, the short-term overload resistance test is related to the type and content of glass in the metallic Al paste. Only the RO—Zn—B-based glass is most helpful to improve the short-term overload resistance test for the Al electrode. In FIG. 6, a comparison is shown for the short-term overload resistance tests between the chip resistors separately fabricated with a conductive Al paste using the Bi—Zn—B-based glass 61 and a conductive Al paste using the RO—Zn—B-based glass 62 both sintered under 850° C. The RO—Zn—B-based glass is a conductive polaron glass and this kind of glass helps instantly directing out high-voltage load energy. The above characteristic of the conductive polaron glass is the main key for the short-term overload resistance tests.

Besides, the present invention uses the anti-plating treatment to solve the problem where metal plating followed is hard to be processed owing to an oxide layer generated on electrode surface even though the Al paste using the RO—Zn—B-based glass achieves high density after being sintered.

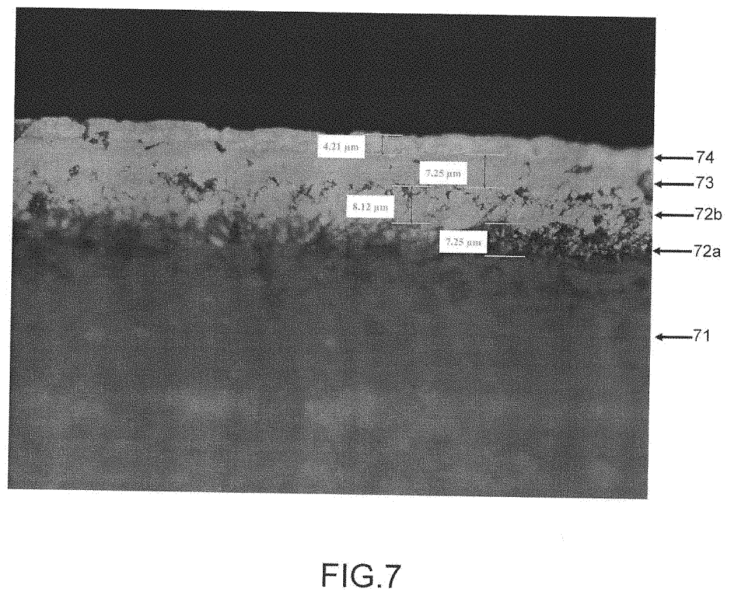

Finally, a high-temperature Al electrode 72a is obtained on an alumina ceramic substrate 71 through a high-temperature sintering (above the melting point of metallic Al (660° C.), about 850° C.); and, then, a cryogenic Al electrode 72b is formed through a low-temperature sintering (below the melting point of metallic Al, about 600° C.), whose structure of two-layer Al electrode plated with nickel and tin 73,74 is shown in FIG. 7. The structure solves the following problems for the Al electrode of the chip resistor: (1) regarding adhesion to substrate (by the high-temperature Al electrode 72a); (2) regarding plated metal, such as nickel, tin, etc. (by the low-temperature Al electrode 72b); and (3) regarding short-term overload voltage test (by the two-layer Al electrode), as also shown in FIG. 6.

TABLE 1

| | | Solid | Sintering | Resistance | Thermostability | Short-term |
|---|---|---|---|---|---|---|
| | Proportion | content | temperature | rate | ΔR/R | overload test |
| Glass | (wt %) | (wt %) | (° C.) | Ω-cm | (25° C.~200° C.) | ΔR/R |
| Bi₂O₃—ZnO—B₂O₃ | 3 | 70 | 850 | 7 × 10⁻⁷ | ±1-5% | ±5% |
| Bi₂O₃—ZnO—B₂O₃ | 10 | 70 | 850 | 3 × 10⁻⁷ | ±1-5% | ±2% |
| Bi₂O₃—ZnO—B₂O₃ | 20 | 70 | 850 | 5 × 10⁻⁶ | ±1-5% | ±1% |
| SiO₂—ZnO—B₂O₃ | 3 | 70 | 850 | 8 × 10⁻⁷ | ±1-5% | ±5% |
| SiO₂—ZnO—B₂O₃ | 10 | 70 | 850 | 4 × 10⁻⁷ | ±1-5% | ±3% |
| SiO₂—ZnO—B₂O₃ | 20 | 70 | 850 | 7 × 10⁻⁶ | ±1-5% | ±3% |
| P₂O₅—ZnO—B₂O₃ | 3 | 70 | 850 | 8 × 10⁻⁷ | ±1-5% | ±3% |
| P₂O₅—ZnO—B₂O₃ | 10 | 70 | 850 | 2 × 10⁻⁷ | ±1-5% | ±2% |
| P₂O₅—ZnO—B₂O₃ | 20 | 70 | 850 | 8 × 10⁻⁶ | ±1-5% | ±1% |
| PbO—ZnO—B₂O₃ | 3 | 70 | 850 | 2 × 10⁻⁷ | ±1-5% | ±3% |
| PbO—ZnO—B₂O₃ | 10 | 70 | 850 | 2 × 10⁻⁷ | ±1-5% | ±2% |
| PbO—ZnO—B₂O₃ | 20 | 70 | 850 | 3 × 10⁻⁶ | ±1-5% | ±1% |
| V₂O₅—ZnO—B₂O₃ | 3 | 60 | 600 | 5 × 10⁻⁶ | ±1% | <±0.4% |
| V₂O₅—ZnO—B₂O₃ | 10 | 60 | 600 | 6 × 10⁻⁷ | ±0.8% | <±0.1% |
| V₂O₅—ZnO—B₂O₃ | 20 | 60 | 600 | 2 × 10⁻⁵ | ±0.5% | <±0.2% |
| V₂O₅—ZnO—B₂O₃ | 30 | 60 | 600 | 9 × 10⁻⁵ | ±1% | <±0.3% |
| V₂O₅—ZnO—B₂O₃ | 3 | 60 | 850 | 4 × 10⁻⁶ | <±0.2% | <±0.1% |
| V₂O₅—ZnO—B₂O₃ | 10 | 60 | 850 | 7 × 10⁻⁷ | <±0.1% | <±0.1% |
| V₂O₅—ZnO—B₂O₃ | 20 | 60 | 850 | 6 × 10⁻⁵ | <±0.1% | <±0.1% |
| V₂O₅—ZnO—B₂O₃ | 30 | 60 | 850 | 9 × 10⁻⁵ | <±0.2% | <±0.1% |
| V₂O₅—ZnO—B₂O₃ | 3 | 70 | 600 | 1 × 10⁻⁶ | ±0.8% | <±0.1% |
| V₂O₅—ZnO—B₂O₃ | 10 | 70 | 600 | 1 × 10⁻⁷ | ±0.5% | <±0.1% |
| V₂O₅—ZnO—B₂O₃ | 20 | 70 | 600 | 1 × 10⁻⁶ | ±0.5% | <±0.1% |
| V₂O₅—ZnO—B₂O₃ | 30 | 70 | 600 | 3 × 10⁻⁵ | ±0.7% | <±0.1% |
| V₂O₅—ZnO—B₂O₃ | 3 | 70 | 850 | 9 × 10⁻⁷ | <±0.2% | <±0.1% |
| V₂O₅—ZnO—B₂O₃ | 10 | 70 | 850 | 2 × 10⁻⁷ | <±0.1% | <±0.1% |
| V₂O₅—ZnO—B₂O₃ | 20 | 70 | 850 | 3 × 10⁻⁶ | <±0.1% | <±0.1% |
| V₂O₅—ZnO—B₂O₃ | 30 | 70 | 850 | 5 × 10⁻⁵ | <±0.3% | <±0.1% |
| V₂O₅—ZnO—B₂O₃ | 3 | 80 | 600 | 6 × 10⁻⁷ | ±0.5% | <±0.1% |
| V₂O₅—ZnO—B₂O₃ | 10 | 80 | 600 | 1 × 10⁻⁷ | ±0.2% | <±0.1% |
| V₂O₅—ZnO—B₂O₃ | 20 | 80 | 600 | 2 × 10⁻⁶ | ±0.3% | <±0.1% |
| V₂O₅—ZnO—B₂O₃ | 30 | 80 | 600 | 1 × 10⁻⁵ | ±0.4% | <±0.1% |
| V₂O₅—ZnO—B₂O₃ | 3 | 80 | 850 | 6 × 10⁻⁷ | <±0.1% | <±0.1% |
| V₂O₅—ZnO—B₂O₃ | 10 | 80 | 850 | 1 × 10⁻⁷ | <±0.1% | <±0.1% |
| V₂O₅—ZnO—B₂O₃ | 20 | 80 | 850 | 5 × 10⁻⁶ | <±0.1% | <±0.1% |
| V₂O₅—ZnO—B₂O₃ | 30 | 80 | 850 | 3 × 10⁻⁵ | <±0.1% | <±0.1% |
| SiO₂ + V₂O₅—ZnO—B₂O₃ | 10 | 80 | 850 | 3 × 10⁻⁷ | ±0.1% | <±0.01% |
| MnO₂ + V₂O₅—ZnO—B₂O₃ | 10 | 80 | 850 | 3 × 10⁻⁷ | ±0.1% | <±0.01% |
| CuO + V₂O₅—ZnO—B₂O₃ | 10 | 80 | 850 | 3 × 10⁻⁷ | ±0.1% | <±0.01% |
| Cr₂O₃ + V₂O₅—ZnO—B₂O₃ | 10 | 80 | 850 | 3 × 10⁻⁷ | ±0.1% | <±0.01% |
| ZrO₂ + V₂O₅—ZnO—B₂O₃ | 10 | 80 | 850 | 5 × 10⁻⁷ | ±0.1% | <±0.01% |
| Al₂O₃ + V₂O₅—ZnO—B₂O₃ | 10 | 80 | 850 | 4 × 10⁻⁷ | ±0.1% | <±0.01% |
| ZnO + V₂O₅—ZnO—B₂O₃ | 10 | 80 | 850 | 4 × 10⁻⁷ | ±0.1% | <±0.01% |
| Li₂O + V₂O₅—ZnO—B₂O₃ | 10 | 80 | 850 | 3 × 10⁻⁷ | ±0.1% | <±0.01% |

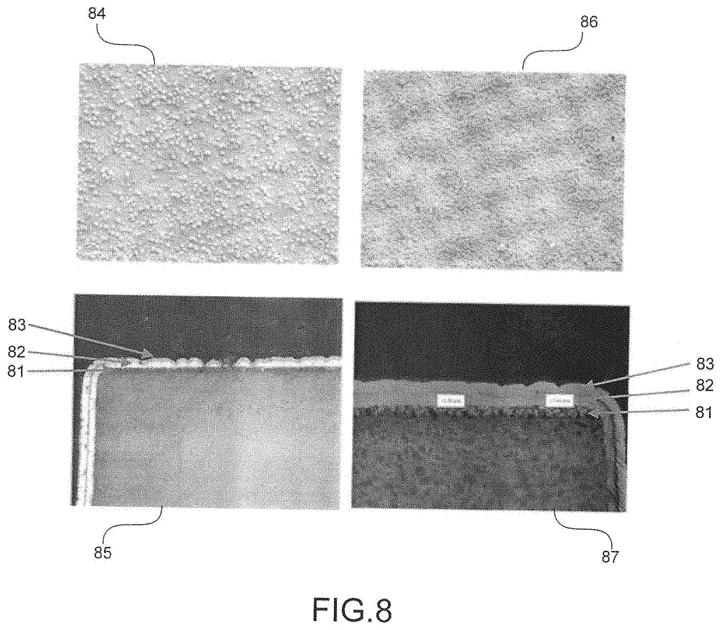

The present invention uses an Al terminal electrode 81 to replace the original Ag terminal electrode. The chip resistors plated with nickel and tin 82,83 are shown in FIG. 8. Therein, a surface 84 for plated nickel and a sectional view 85 for plated nickel/tin both obtained through non-anti-plating treatment are included along with a surface 86 for plated nickel and a sectional view 87 for plated nickel/tin both obtained through anti-plating treatment.

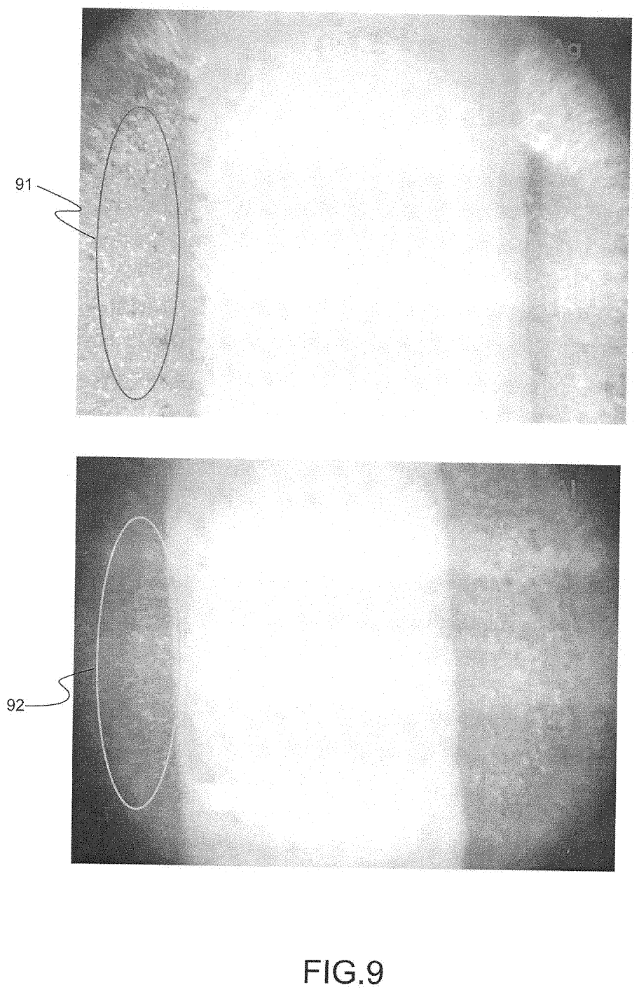

The present invention compares the Ag electrode and the Al electrode of the chip resistor under high voltage and high humidity as shown in FIG. 9. Therein, Ag 91 exhibits yellow-like, which shows the material migration of the Ag electrode; and Al 92 exhibits clean with nothing generated, which shows none material migration of the AI electrode.

Hence, the thick-film-printed Al electrode proposed according to the present invention has the following features:

(1) The material cost is significantly reduced by replacing the original Ag terminal electrode with the Al terminal electrode.

(2) The original sulfurization problem for chip resistor is completely overcome by replacing the original Ag terminal electrode with the Al terminal electrode, which greatly benefits the applications of the chip resistors in the field of automobile electronics.

To sum up, the present invention is a thick-film Al electrode paste with a pretreatment before metal plating for fabricating a chip resistor, where the chip resistor having electrodes fabricated with the thick-film Al paste improves its ability on anti-sulfurization and solves the conventional problem of material migration of the Ag electrode under high voltage and high humidity; and the material cost of the terminal electrode of the chip resistor is also significantly reduced.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A composition of thick-film aluminum (Al) electrode paste, said composition being of a conductive Al paste to obtain a terminal electrode of a chip resistor on an Al ceramic substrate, said composition comprising an RO-zinc(Zn)-boron(B)-based glass, a metal oxide (MO), Al granules, and an organic additive,
wherein, in the total weight of said RO—Zn—B-based glass, said MO, said Al granules, and said organic additive, said RO—Zn—B-based glass has a content of 3˜30 wt %, said MO has a content of 0.1˜15 wt %, said Al granules has a content of 50˜70 wt %, and said organic additive has a content of 1020 wt %; and said RO—Zn—B-based glass is selected from a group consisting of a vanadium(V)—Zn—B-based glass (V₂O₅—ZnO—B₂O₃) and a barium(Ba)—Zn—B-based glass (BaO—ZnO—B₂O₃).

2. The composition according to claim 1,
wherein said MO comprises silicon oxide (SiO₂), manganese oxide (MnO₂), copper oxide (CuO), chromium oxide (Cr₂O₃), zirconium oxide (ZrO₂), aluminum oxide (Al₂O₃), boron oxide (B₂O₃), zinc oxide (ZnO), and lithium oxide (Li₂O); and, in the total weight of said SiO₂, MnO₂, CuO, Cr₂O₃, ZrO₂, Al₂O₃, B₂O₃, ZnO, and Li₂O, SiO₂ has a content of 115 wt %; MnO₂ has a content of 115 wt %; CuO has a content of 115 wt %; Cr₂O₃ has a content of 1˜15 wt %; ZrO₂ has a content of 1˜15 wt %; Al₂O₃ has a content of 1˜5 wt %; B₂O₃ has a content of 25˜30 wt %; ZnO has a content of 25˜30 wt %; and Li₂O has a content of 1˜5 wt %.

3. The composition according to claim 1,
wherein said thick-film Al electrode paste is applied on said alumina ceramic substrate to obtain said thick-film Al electrode through drying and sintering;
wherein a pretreatment is processed before subsequent metal plating;
wherein said pretreatment is an anti-plating treatment to remove surface irregularities and nonconductive alumina on a surface of said thick-film Al electrode to smooth flat surface with low oxygen content; and
wherein a chip resistor using said thick-film Al electrode has characteristics equivalent to those using thick-film printed silver electrode and those using thick-film printed copper electrodes sintered in a reducing atmosphere.

4. The composition according to claim 3,
wherein, with said thick-film Al electrode paste, said thick-film Al electrode is obtained by forming a high-temperature sintered Al layer on said alumina ceramic substrate through sintering at a high temperature above the melting point of Al; and, then, forming a cryogenic sintered Al layer on said alumina ceramic substrate through sintering at a low temperature below the melting point of Al.
